(19) United States
(12) Patent Application Publication
(10) Pub. No.: US 2024/0165443 A1
(43) Pub. Date: May 23, 2024

(54) SOLID-STATE FIRE SUPPRESSION

(71) Applicant: Kidde Technologies Inc., Wilson, NC (US)

(72) Inventors: Paul Papas, West Hartford, CT (US); Adam Chattaway, Windsor (GB); Jeffrey Angle, Knightdale, NC (US); Lloyd Kent Ballard, Raleigh, NC (US)

(21) Appl. No.: 17/992,585

(22) Filed: Nov. 22, 2022

(51) Int. Cl. A62C 5/00

(52) U.S. Cl. CPC A62C 5/004; A62C 5/00

(57) ABSTRACT

A fire suppression system comprises an electric solid propellant (ESP) configured as a solid mass, and a circuit configured to flow current through the ESP. The ESP includes a polymer material, an oxidizer, and at least one chemical additive. The circuit includes a power source, an anode in physical communication with the ESP, and a cathode in physical communication with the ESP and oppositely disposed from the anode.

### BACKGROUND

The present disclosure relates generally to fire suppression agents and systems, and more specifically to solid state fire suppression agents.

Many aerospace fire suppressant agents are known, including halon-based agents, foams, inert gas, trifluoromethyl iodide (CF3I), hydrofluorocarbons (HFCs), fluoroketones (FKs), and water mist. Due to ongoing concerns of stratospheric ozone depletion and global warming considerations, production of halons has ceased and production of hydrofluorocarbon-based agents is being tapered. It is therefore desired, and soon will be required, to use non-ozone depleting alternative agents for all new aircraft, and in the future to retrofit older aircraft with such alternative agents.

### SUMMARY

A fire suppression system comprises an electric solid propellant (ESP) configured as a solid mass, and a circuit configured to flow current through the ESP. The ESP includes a polymer material, an oxidizer, and at least one chemical additive. The circuit includes a power source, an anode in physical communication with the ESP, and a cathode in physical communication with the ESP and oppositely disposed from the anode.

A method of activating an electric solid propellant (ESP) to generate inert gas comprises flowing current through the ESP with a circuit, the circuit including a power source, an anode in physical communication with the ESP, and a cathode in physical communication with the ESP and oppositely disposed from the anode. Flowing current through the ESP causes a chemical decomposition of a polymer material and an oxidizer of the ESP to form the inert gas.

A fire suppression system comprises at least one container including an electric solid propellant (ESP) configured as solid mass, and a circuit at least configured flow current through the solid mass. The ESP includes a polymer material, an oxidizer, and at least one chemical additive. The circuit includes a power source, an anode in physical communication with the ESP, and a cathode in physical communication with the ESP and oppositely disposed from the anode.

### BRIEF DESCRIPTION OF THE DRAWINGS

FIG. 1 is a schematic illustration of a solid-state fire suppression agent and a circuit used to activate and deactivate the fire suppression agent.

FIG. 2 is a schematic illustration of a fire suppression system incorporating the fire suppression agent and circuit of FIG. 1.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

A fire suppression system using an electric solid propellant (ESP) to generate inert gases is disclosed herein. A mass of an ESP can be used as a fire suppression agent and connected to a circuit for selectively activating/deactivating the electrochemical and thermal decomposition of the ESP into inert gases suitable for fire suppression. The ESP(s) can be incorporated into containers similar to existing fixed or portable fire suppression systems.

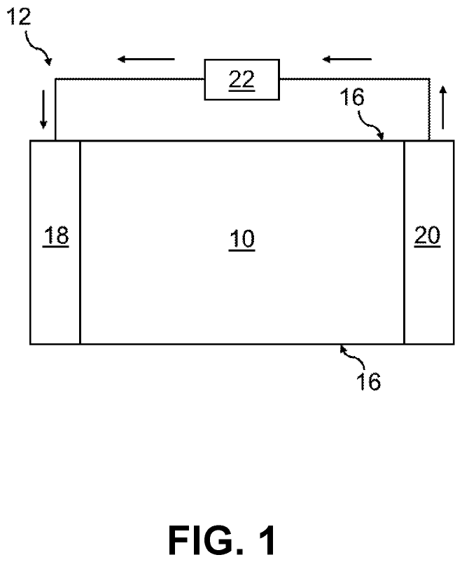

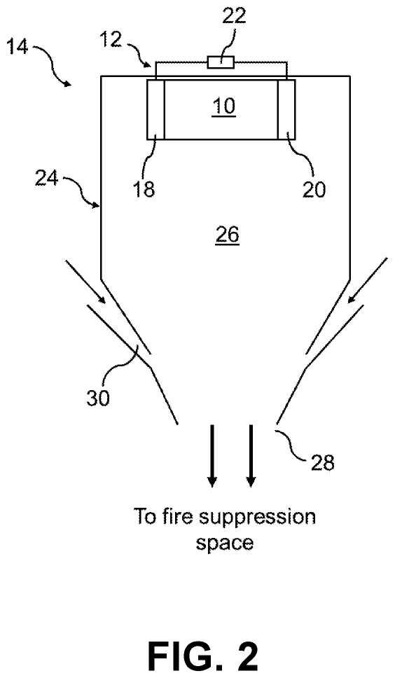

FIG. 1 is a schematic illustration of a solid-state fire suppression agent 10 (hereinafter referred to as “agent 10”) and circuit 12. FIG. 2 is a schematic illustration of fire suppression system 14 employing solid fire suppression agent 10. FIGS. 1 and 2 are discussed together.

Agent 10 is an ESP formed from a polymer material (e.g., polyvinyl alcohol—PVA, and/or polyvinyl amine nitrate—PVAN) and an oxidizer (e.g., hydroxyl-ammonium nitrate—HAN, hydrazine nitrate—HN, and/or ammonium nitrate—AN). Agent 10 can further include one or more chemical additives (e.g., burning rate modifiers, cross-linking agents, etc.) to improve agent performance and/or mechanical properties. Agent 10 can include near stoichiometric proportions of the polymer, oxidizer, and chemical additive(s) in an exemplary embodiment to minimize excess production of undesirable species. For example, relatively high proportions of the oxidizer can lead to excess oxygen (O₂) which can fuel a fire, and relatively high proportions of the polymer material can lead to excess carbon monoxide (CO). Other polymers, oxidizers, and additives are contemplated herein. Agent 10 can be formed into a solid mass of a three-dimensional shape (e.g., a cubic or cylindrical block). Agent 10 can be classified as a non-flammable solid material which cannot be ignited by an external flame. Instead, circuit 12 can be used to apply an electric current across agent 10, which initiates a chemical decomposition of agent 10 resulting in the formation of gaseous carbon dioxide (CO₂) and nitrogen (N₂), among other byproducts. The former is formed, in part, from the breakdown of the polymer's carbon-carbon backbone, and the latter from reactions of the nitrogen-containing oxidizer. Gases are generated within the reaction (i.e., combustion) zone formed within the material between anode 18 and cathode 20 (described in greater detail below) and liberated from surfaces 16 (only two are labeled in FIG. 1) of agent 10.

Circuit 12 can be configured as type of electrolytic cell having anode 18 and cathode 20 oppositely disposed from one another and in physical contact with agent 10, and power source 22. Anode 18, cathode 20, power source 22, and agent 10 are in electrical communication with one another. Anode 18 can be oxidizing and cathode 20 can be reducing. Each can be formed from a conductive material (e.g., tungsten, silver, platinum, aluminum, copper, stainless steel, etc.). In an alternative embodiment, circuit 12 can be arranged as a coaxial circuit. Such an embodiment can include a concentrically inner most electrode (e.g., cathode 20) arranged as a tube or solid rod, and a concentrically outermost electrode (e.g., anode 18) arranged as a tube. Agent 10 can be disposed between and in physical contact with the two electrodes.

Power source 22 can be an external source of DC power in electrical communication with circuit 12, a battery, and in an exemplary embodiment, can include an external source of DC power as a primary source, and a battery as a backup, to comply with various regulations governing, for example, commercial and military aircraft. In an alternative embodiment, power source 22 can be a source of AC power. Power source 22 can supply a voltage ranging from 50 V to 400 V, from 150 V to 250 V, and in an exemplary embodiment, 200 V. The actual initiating voltage, or initiating current density threshold, can vary depending on other factors such as pressure and ESP composition. When the power is “on”, current flows through circuit 12 and agent 10. Current moves from cathode 20 toward anode 18 as indicated by arrows in FIG. 1. The current within circuit 12 can range from, for example, 35 mA to 450 mA.

Fire suppression system 10 can include one or more containers 24, although only one is shown in FIG. 2, of agent 10 circuit 12 within inner volume 26 of container 24. Power source 22 can be physically located exterior or interior to container 24. Container 24 can be portable (i.e., a handheld extinguisher) or fixed in position. Container 24 further includes outlet 28 and optional air mixing apertures 30 proximate but upstream of outlet 28. In one embodiment, container 24 can be placed in direct flow communication with a fire suppression space (i.e., the space designated as requiring fire suppression from system 10), and in such embodiment, can require no piping or tubing to carry inert gases to another location. In an alternative embodiment, container 24 can be placed within a bulkhead (e.g., of an aircraft) and an intervening container and/or piping can carry inert gases to the fire suppression space. In aircraft, a fire suppression space can be a cargo hold or a gas turbine engine nacelle, to name a few non-limiting examples. In non-aerospace applications, a fire suppression space can be located within a terrestrial or marine vehicle, or a building.

Air mixing apertures 30 can be used to entrain air from the surrounding environment into internal volume 26 to mix with and cool inert gases generated from the activation of agent 10. Air mixing apertures 30 can have an eductor geometry, as shown in FIG. 2, to facilitate air entrainment, or can have a more cylindrical shape in an alternative embodiment. The number of air mixing apertures disposed within container 24 can be controlled based on the level of cooling needed, without causing too much dilution of the inert gas. In an alternative embodiment, the gases produced by the decomposition of agent 10 can be cooled by passing them through a heat exchanger (e.g., ceramic honeycomb) to dissipate heat. In an alternative embodiment, the gases produced by the decomposition of agent 10 can be cooled by mixing them with a liquid agent, such as water, to cool the product decomposition gases through dispersion (e.g., atomization) or heat absorption and/or evaporation of the liquid agent.

In operation of fire suppression system 14, agent(s) 10 can be activated to generate inert gases via when a power source 22 is “on” and providing power to a respective circuit 12 to create a flow of current. Whenever power source 22 is “off” (i.e., not powering circuit 12), the reactions cease, and unlike other types of solid-state propellants, agent 10 does not continue decomposing and generating gases once in this deactivated state. Thus, agent 10 is selectively operable to generate inert gases for fire suppression by the switching “on” and/or “off” of the respective power source 22. This can occur manually (e.g., by a crew member) via a control panel, by a handle for a portable container 24, or automatically by a control system (e.g., when triggered by a threshold parameter). In this regard, power source 22 can also be used to control the rate of formation of inert gases by switching “on” and/or “off” in a periodic manner.

The disclosed fire suppression system and agent have many benefits over existing agents and systems. The solid-state agent is a non-flammable solid, and thus suitable for aerospace and other vehicular applications. Additionally, the combined weight of the agent and a respective container is relatively low compared to current agents requiring pressurized containers which can reach or exceed 75 lbs. in some cases. Each of the disclosed containers can be lighter and/or more compact than their counterpart containers in a current fire suppression system. Finally, the inert gases generated by the disclosed solid-state agent are more environmentally friendly (i.e., having zero ozone depletion potential and global warming impact) than halon and hydrofluorocarbon-based agents, and should not be impacted by future regulatory bans.

### DISCUSSION OF POSSIBLE EMBODIMENTS

The following are non-exclusive descriptions of possible embodiments of the present invention.

A fire suppression system comprises an electric solid propellant (ESP) configured as a solid mass, and a circuit configured to flow current through the ESP. The ESP includes a polymer material, an oxidizer, and at least one chemical additive. The circuit includes a power source, an anode in physical communication with the ESP, and a cathode in physical communication with the ESP and oppositely disposed from the anode.

The fire suppression system of the preceding paragraph can optionally include, additionally and/or alternatively, any one or more of the following features, configurations and/or additional components:

In the above fire suppression system, the polymer material can include at least one of polyvinyl alcohol and polyvinyl amine nitrate.

In any of the above fire suppression systems, the oxidizer can include at least one of hydroxyl-ammonium nitrate, hydrazine nitrate, and ammonium nitrate.

In any of the above fire suppression systems, the at least one chemical additive can include at least one of a burn rate modifier and a cross-linking agent.

Any of the above fire suppression systems can further include at least one container having an internal volume, and the ESP can be disposed within the internal volume of the at least one container.

Any of the above fire suppression systems can further include an outlet fluidly connected to a fire suppression space, and a plurality of air mixing apertures fluidly connecting the internal volume with ambient air external to the container.

In any of the above fire suppression systems, the outlet can be directly fluidly connected to the fire suppression space.

In any of the above fire suppression systems, the fire suppression space can include at least one of an aircraft cargo hold and a gas turbine engine nacelle.

A method of activating an electric solid propellant (ESP) to generate inert gas comprises flowing current through the ESP with a circuit, the circuit including a power source, an anode in physical communication with the ESP, and a cathode in physical communication with the ESP and oppositely disposed from the anode. Flowing current through the ESP causes a chemical decomposition of a polymer material and an oxidizer of the ESP to form the inert gas.

The method of the preceding paragraph can optionally include, additionally and/or alternatively, any one or more of the following features, configurations and/or additional components:

In the above method, flowing current through the ESP can include supplying between 50 V and 400 V with the power source.

In any of the above methods, the current can range from 35 mA to 450 mA.

In any of the above methods, the polymer material can include at least one of polyvinyl alcohol and polyvinyl amine nitrate.

In any of the above methods, the inert gas can include carbon dioxide.

In any of the above methods, the oxidizer can include at least one of hydroxyl-ammonium nitrate, hydrazine nitrate, and ammonium nitrate.

In any of the above methods, the inert gas can include nitrogen.

Any of the above methods can further include cooling the inert gas using ambient air.

Any of the above methods can further include ceasing the current flowing through the circuit to cease the generation of the inert gas.

A fire suppression system comprises at least one container including an electric solid propellant (ESP) configured as solid mass, and a circuit at least configured flow current through the solid mass. The ESP includes a polymer material, an oxidizer, and at least one chemical additive. The circuit includes a power source, an anode in physical communication with the ESP, and a cathode in physical communication with the ESP and oppositely disposed from the anode.

The fire suppression system of the preceding paragraph can optionally include, additionally and/or alternatively, any one or more of the following features, configurations and/or additional components:

In the above fire suppression system, the polymer material can include at least one of polyvinyl alcohol and polyvinyl amine nitrate, the oxidizer can include at least one of hydroxyl-ammonium nitrate, hydrazine nitrate, and ammonium nitrate, and the at least one chemical additive can include at least one of a burn rate modifier and a cross-linking agent.

In any of the above fire suppression systems, the power source can be external to the at least one container.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire suppression system comprising:
an electric solid propellant (ESP) configured as a solid mass, the ESP comprising:
a polymer material;
an oxidizer; and
at least one chemical additive; and
a circuit configured to flow current through the ESP, the circuit comprising:
a power source;
an anode in physical communication with the ESP; and
a cathode in physical communication with the ESP and oppositely disposed from the anode.

2. The fire suppression system of claim 1, wherein the polymer material comprises at least one of polyvinyl alcohol and polyvinyl amine nitrate.

3. The fire suppression system of claim 1, wherein the oxidizer comprises at least one of hydroxyl-ammonium nitrate, hydrazine nitrate, and ammonium nitrate.

4. The fire suppression system of claim 1, wherein the at least one chemical additive comprises at least one of a burn rate modifier and a cross-linking agent.

5. The fire suppression system of claim 1 and further comprising:
at least one container having an internal volume;
wherein the ESP is disposed within the internal volume of the at least one container.

6. The fire suppression system of claim 5, wherein the container comprises:
an outlet fluidly connected to a fire suppression space; and
a plurality of air mixing apertures fluidly connecting the internal volume with ambient air external to the container.

7. The fire suppression system of claim 6, wherein the outlet is directly fluidly connected to the fire suppression space.

8. The fire suppression system of claim 6, wherein the fire suppression space comprises at least one of an aircraft cargo hold and a gas turbine engine nacelle.

9. A method of activating an electric solid propellant (ESP) to generate inert gas, the method comprising:
flowing current through the ESP with a circuit, the circuit comprising:
a power source;
an anode in physical communication with the ESP; and
a cathode in physical communication with the ESP and oppositely disposed from the anode;
wherein flowing current through the ESP causes a chemical decomposition of a polymer material and an oxidizer of the ESP to form the inert gas.

10. The method of claim 9, wherein flowing current through the ESP comprises: supplying between 50 V and 400 V with the power source.

11. The method of claim 10, wherein the current ranges from 35 mA to 450 mA.

12. The method of claim 9, wherein the polymer material comprises at least one of polyvinyl alcohol and polyvinyl amine nitrate.

13. The method of claim 12, wherein the inert gas comprises carbon dioxide.

14. The method of claim 9, wherein the oxidizer comprises at least one of hydroxyl-ammonium nitrate, hydrazine nitrate, and ammonium nitrate.

15. The method of claim 14, wherein the inert gas comprises nitrogen.

16. The method of claim 9 and further comprising: cooling the inert gas using ambient air.

17. The method of claim 9 and further comprising: ceasing the current flowing through the circuit to cease the generation of the inert gas.

18. A fire suppression system comprising:
at least one container comprising:
an electric solid propellant (ESP) configured as solid mass, the ESP comprising:
a polymer material;
an oxidizer; and
at least one chemical additive; and
a circuit at least configured flow current through the solid mass, the circuit comprising:
a power source;
an anode in physical communication with the ESP; and
a cathode in physical communication with the ESP and oppositely disposed from the anode.

19. The fire suppression system of claim 18, wherein:
the polymer material comprises at least one of polyvinyl alcohol and polyvinyl amine nitrate;
the oxidizer comprises at least one of hydroxyl-ammonium nitrate, hydrazine nitrate, and ammonium nitrate; and
the at least one chemical additive comprises at least one of a burn rate modifier and a cross-linking agent.

20. The fire suppression system of claim 18, wherein the power source is external to the at least one container.
